(19) United States
(12) Patent Application Publication
(10) Pub. No.: US 2012/0305478 A1
(43) Pub. Date: Dec. 6, 2012

(54) Method of Treating Wastewater and Producing an Activated Sludge Having a High Biopolymer Production Potential

(75) Inventors: Alan Gideon Werker, Lomma (SE); Simon Olof Harald Bengtsson, Lund (SE); Fernando Morgan-Sagastume, Malmo (SE); Carl Anton Börje Karlsson, Lund (SE); Elise Marie Blanchet, Poissy (FR)

(73) Assignee: VEOLIA WATER SOLUTIONS & TECHNOLOGIES SUPPORT, Saint-Maurice Cedex (FR)

(21) Appl. No.: 13/516,760

(22) PCT Filed: Jul. 29, 2010
(86) PCT No.: PCT/IB10/01884

§ 371 Date: Aug. 22, 2012

Related U.S. Application Data
(60) Provisional application No. 61/287,889, filed on Dec. 18, 2009.

(51) Int. Cl. C02F 3/12; C02F 3/34

(52) U.S. Cl. 210/607; 210/620; 210/608

(57) ABSTRACT

A method or process is provided for treating wastewater and producing a polyhydroxyalkanote (PHA)-storing biomass. The method or process entails biologically treating wastewater and in one process a filamentous biomass is selected and caused to proliferate so as to dominate an activated sludge. The filamentous biomass is utilized to treat the wastewater and to remove contaminants therefrom. As a part of this process, there is provided an enhancement for PHA production potential in the said biomass. This entails enhancing the PHA production potential of the filamentous biomass by subjecting the biomass to alternating feast and famine conditions where under feast conditions more biodegradable organic substrate is available to the filamentous biomass than under famine conditions. In another process, wastewater is treated with an activated sludge. The wastewater is treated in a main stream and as a part of the process, the activated sludge and biomass contained therein is concentrated and directed to a side stream. In the side stream, at least a portion of the enhancement for PHA production potential in the biomass from the process is carried out. In one particular process, the activated sludge and the biomass contained therein is concentrated by a separator and the concentrated biomass is directed to a side stream and subjected to famine conditions.

### FIELD OF THE INVENTION

The present invention relates to wastewater treatment and biopolymer production, and more particularly, to an activated sludge wastewater treatment process producing a filamentous biomass exhibiting a high potential for polyhydroxyalkanoate production.

### BACKGROUND

It is known that biomass contained in activated sludge wastewater treatment processes may exhibit the potential for biopolymer production. Specifically, it is known that some bacteria found in activated sludge (open mixed microbial culture) processes can produce polyhydroxyalkanoates (PHAs). PHAs are biopolymers that can be extracted from biomass, compounded into plastics, and/or further converted into certain chemicals and have the benefit of being entirely biodegradable.

Many different processes exist today where activated sludge, and the biomass that makes up the activated sludge, is used to remove organic contaminants from wastewater. In addition, nitrification, denitrification, combined nitrification/denitrification, and phosphorus removal processes are generally performed through activated sludge processes.

Activated sludge is comprised of living microorganisms as well as non-living suspended matter. Biomass is an expression of the amount of activated sludge in a process as biomass is typically quantified by standardized methods as the dry weight of suspended matter in activated sludge mixed liquors. The living component may be comprised of species of bacteria, archaea, fungi/yeast, protozoa, metazoa, algae, and viruses. An activated sludge biomass that exhibits potential for biopolymer production is characteristic in terms of its enrichment in microorganisms which can store polyhydroxyalkanoates as an intracellular source of carbon and energy.

Biological wastewater treatment processes that are effective in treating wastewater are normally not effective in producing PHA. Likewise, biological processes that are effective in producing biomass rich in PHA may not always be effective in treating wastewater. Most activated sludge processes aim to cultivate a non-filamentous biomass. Indeed, most biological wastewater treatment processes go to lengths to avoid biomass that is dominated by filamentous bacteria that characteristically have high surface area. Indeed, entire books have been written describing how to avoid filamentous biomass in wastewater treatment processes. In addition, many patents directed to biological wastewater treatment discuss the problems associated with filamentous biomass. See for example, U.S. Pat. No. RE 32429. In this patent the inventor discusses the problems caused by dominating filamentous microorganisms. The problem addressed is the proliferation of high surface area and/or filamentous bacteria which do not settle adequately in a clarifier. Thus, the consequence of excessively filamentous biomass is the inability to separate the biomass from the treated wastewater and this of course leads to what is often referred to as sludge bulking.

Yet some filamentous bacteria have the potential to be very effective at accumulating PHA. Thus, the present invention is directed to a method or process of providing services of wastewater treatment that is both effective in removing organic contaminants from the wastewater, and at the same time cultivates and gives rise to a biomass having a high PHA accumulation potential. The utilization of a filamentous biomass for PHA production can have several advantages with respect to polymer harvesting from the biomass and nutrient demand in the process.

### SUMMARY

The present invention relates to a biological wastewater treatment process that selects filamentous biomass and conditions the biomass such that the filamentous biomass proliferates and becomes dominant in the activated sludge.

In one particular embodiment, the present invention includes a method for treating wastewater with filamentous biomass and producing a PHA storing filamentous biomass under conditions where the filamentous biomass is selected and caused to proliferate to dominate an activated sludge. The method includes mixing wastewater with activated sludge and selecting filamentous biomass and causing the filamentous biomass to proliferate and dominate over non-filamentous biomass in the activated sludge. Further, the process entails treating the wastewater with the filamentous biomass and utilizing the filamentous biomass to remove contaminants from the wastewater. The method also includes a PHA enhancement process. Here the process entails enhancing the PHA production potential of the filamentous biomass by subjecting the biomass to alternating feast and famine conditions where under feast conditions, more biodegradable organic substrate is available to the filamentous biomass than under famine conditions. The method further includes separating the PHA enhanced filamentous biomass from the wastewater such that PHA can be removed from the biomass in a later stage.

In another embodiment, the present invention entails a wastewater treatment method that produces a PHA storing biomass. Here, the method includes a PHA enhancement process that enhances the PHA production potential of the biomass by subjecting the biomass to alternating feast and famine conditions. In one embodiment of the method or process, at least a portion of the PHA production enhancement potential occurs in a side stream.

### BRIEF DESCRIPTION OF THE DRAWINGS

FIG. 1 is a schematic illustration of a sequencing batch reactor utilized to carry out one process embodiment of the present invention.

FIG. 2 is a schematic illustration of a plug flow wastewater treatment system and process for carrying out one process embodiment of the present invention.

FIG. 3 is a schematic illustration showing a wastewater treatment process for treating wastewater and enhancing the PHA production potential of biomass used in the wastewater treatment, and wherein biomass is subjected to famine conditions in a sidestream.

FIG. 4 is a schematic illustration showing an alternative to the FIG. 3 process, and particularly illustrating the use of a biological treatment reactor downstream of a feast reactor in the mainstream of the process.

FIG. 5 illustrates another alternative process similar to FIGS. 3 and 4, but which includes two separators in the mainstream.

FIG. 6 shows another alternative process similar to the FIG. 5 process, but wherein there is shown two famine reactors in the sidestream.

FIG. 7 is a group of photographs showing phase contrast micrograph (A) with corresponding Nile blue staining micrograph (B). Differential interference contrast micrograph (C) with corresponding FISH image with probes for Meganema perideroedes labeled with Cy3 (D). It is noted that the micrographs were taken with a magnification of 630×.

FIG. 8 is a second group of photographs. These photographs show differential interference contrast micrographs (a, c and d) of the filamentous bacteria Meganema perideroedes (c) and Sphaerotilus natans (d) present in the bulking sludge. Further a florescence micrograph (b) of the selectively identified Meganema perideroedes bacterium (white) and other bacteria in the background, including S. natans using fluorescence in-situ hybridization (FISH). Also, in this case a 630× magnification was used and micrographs c and d correspond to close-up images.

### DETAILED DESCRIPTION

The present invention relates to a wastewater treatment process where the process selects filamentous biomass and by the selection process, the filamentous biomass proliferates and becomes dominant in the activated sludge. The filamentous biomass is mixed with the wastewater, and the activated sludge including the filamentous biomass is effective to biologically treat the wastewater. Biological treatment with respect to removal of organic matter, as well as nitrogen and phosphorus removal, etc., can be carried out in this activated sludge process.

Also forming a part of the method is a process that enriches a filamentous biomass with high PHA accumulation potential. In one embodiment, the filamentous biomass is enriched by what is referred to as feast and famine conditions. During one period of time, relatively large amounts of biodegradable organic substrate is made available to the filamentous biomass. Then, in another period of time, a relatively small amount of biodegradable organic substrate is made available to the filamentous biomass. Through alternating feast and famine conditions, the selection of a PHA accumulating biomass is enhanced.

Further, the method includes separating the biomass enriched in filamentous bacteria from the wastewater. Thereafter, further PHA accumulation may occur followed by PHA processing methods that are distinct from the wastewater treatment, or the enriched PHA containing filamentous biomass may be transported to a remote site for further processing.

One of the basic aims of the present application is to provide a highly efficient wastewater treatment process that is effective in removing organic contaminants. Coupled with this objective, is the objective of providing a highly efficient process that yields a biomass with high PHA accumulation potential. Thus, this process aims at accomplishing both objectives without substantially compromising or undermining either objective.

The method or process of the present invention, as discussed above, centers around selecting filamentous bacteria as contrasted to non-filamentous microorganisms. That is, the process is operated to favor the selection of filamentous biomass such that the filamentous biomass proliferates and comes to dominate the biomass in the activated sludge. Thus, the reactor or reactors utilized in the process of the present invention are operated under conditions that promote the growth and proliferation of filamentous microorganisms and supports their retention in the process. There are a number of controls and operating conditions that can be implemented which encourage the growth and proliferation of filamentous biomass. First, there is solids retention time (SRT). In the present method or process the solids retention time is generally controlled at a level ranging from approximately one day to approximately eight days. Control of the SRT above the hydraulic retention time is based on separation methods that facilitate retention of the filamentous biomass in the process. Some separation methods may be selective towards filamentous networks while being less effective for compact floc structures or dispersed growth of non-filamentous microorganisms. Thus, by implementing an SRT control, the separation methods should help to retain filamentous microorganisms while also tending to wash-out non-filamentous activated sludge microorganisms. One example of implementing SRT control to select filamentous biomass is to implement separation by dissolved air flotation. Based on initial studies, filamentous biomass has been found to be well-suited to dissolved air flotation separation. Good separation can be achieved without addition of chemicals and independent of settling properties. In addition, it should be noted that dissolved air flotation introduces an oxygen rich environment to the biomass which is often a thickened biomass. Thus, the dissolved air flotation separation process can augment or serve as an extension to aerobic famine treatment which, as discussed above and more fully below, promotes selection towards increased PHA accumulation potential of the biomass. Other forms of biomass separation for SRT control may be implemented. For example, a ballasted gravity settling process can be implemented. Here, a ballast, such as microsand, is added to the filamentous biomass. The ballast becomes enmeshed in the filamentous network and this can in some embodiments promote rapid gravity settling. The ballast can be recovered with a hydrocyclone process and recycled. Another form of biomass separation may include micro-sieve filtration. The relatively larger filamentous network makes it amenable to a high rate filtration process such as performed by disc filters.

Further, selection of filamentous biomass can be achieved by various limitations that favor mass transfer to organisms with a high surface-to-volume ratio. For example, making macro-nutrients or trace nutrients available in growth limiting amounts may have the overall effect of selecting filamentous bacteria over non-filamentous bacteria. In addition, providing lower dissolved oxygen (DO) levels in the reactor or reactors may have the effect of selecting filamentous over non-filamentous microorganisms. The feast and famine treatments alluded to above and discussed in more detail below may also contribute to selecting filamentous microorganisms based on readily available organic carbon, especially volatile fatty acids and/or carbohydrates. Finally, the temperature of the process may also contribute to the selection of filamentous biomass. If the hydraulic and sludge retention times and conditions for feast-famine treatment are favorable, temperature and micro-nutrient loading rates can be manipulated to promote for an abundance of filamentous PHA-accumulating microorganisms in the biomass.

Although non-filamentous biomass may also be effective in PHA accumulation, growth of a filamentous PHA accumulating biomass may have several technical and economical advantages. Firstly, the downstream processing may be more efficient with a filamentous biomass. The higher surface to volume ratio means that the intracellular PHA granules are more amendable to separation from the residual biomass. Secondly, the favouring of filaments under nutrient limiting conditions means that a filamentous biomass will have reduced requirements for nutrient addition. Nutrient additions are required in treatment of many industrial wastewaters and may represent substantial costs. Likewise, the use of low levels of dissolved oxygen may reduce requirements for aeration which means energy saving. Furthermore, a reduced dependency on biomass settleability, and application of alternative separation methods, makes it possible to increase the volumetric organic loading rate and thereby reduce the reactor volume. In the end, filamentous biomass is desirable from the standpoint of producing PHA and of significantly contributing to the wastewater treatment without adversely impacting it.

Low or growth limiting micro-nutrient loading rates relative to the organic loading rate (mg micronutrient/mgCODfeed) and lower temperatures in the range 15° to 21° C. can be made to favor the growth of PHA storing filamentous bacteria. Lower temperatures increase the yield of biomass with respect to the organic loading thereby increasing the demand for growth associated micronutrients. Thus lowered temperature can increase the effective scarcity of these inorganic but essential growth elements. The micronutrients that appear to play a role in promoting filamentous abundance when applied in low or limiting rates are: K, S, Mg, Ca, Fe, Zn, Mn, Co, Cu, Mo, B, Cl, V and Na. Filaments with high surface area to bio-volume ratio have an inherent advantage over floc-forming bacteria in mass transfer rates when one or more growth related elements are in scarce supply, or limiting.

SRT or solids retention time, as discussed above, is a control factor in wastewater treatment. SRT impacts the selection of a particular biomass and also plays a role in selecting biomass with high PHA accumulation potential. In biological treatment of wastewater, there is a distinction between hydraulic retention time (HRT) and SRT. Hydraulic retention time is the average retention time of the wastewater in the treatment process and SRT is the average retention time of the biomass. By extending SRT well in excess of HRT, the inventory of biomass in the reactor is increased substantially. SRT control is used to maintain biomass levels such that the degree of microbial activity is sufficient to remove contaminants from the wastewater within the time constraints of HRT. SRT is a useful tool to employ for selecting species of bacteria that can remove these contaminants while also influencing various properties of the biomass. As alluded above, SRT control is further useful in producing a biomass with high PHA accumulating potential. For open culture PHA production, a low SRT dominated biomass has some advantages. Biomass yield and activity increase with reduced SRT. Increased biomass yield makes the process more effective by reducing oxygen consumption. Increased biomass yield also increases the possible yield of PHA production from the wastewater. Finally, digestion of low SRT biomass generally provides for improved biogas production. This suggests that a process that yields substantially more PHA will likely include non-PHA cellular material that after PHA recovery will exhibit superior biogas yields.

It is appreciated that maintaining a low SRT for the purpose of enriching PHA control should not be implemented at the sacrifice of the overall stability and effectiveness of the process in terms of wastewater treatment. That is, the biomass in the process must be effective to remove organic contaminants from the wastewater. If SRT is too short there is the possibility that the biomass will grow dispersed as single cells in solution and such biomass may not be retained without the use of membrane systems

SRT influences the resident concentration of biomass in the process as does the organic loading rate to the process. The specific organic loading rate (that is the mass rate of organic matter added per mass biomass) is a factor for design and stable operation of activated sludge treatment processes. Specific loading rates in excess of established activated sludge design guidelines risk process upset due to rapid biomass growth and associated poor biomass settling characteristics. Rapidly growing biomass is produced with increased yield with respect to organic substrate added. Reactor loading in excess of conventional activated sludge operating practice can be used to provide selective advantage for a biomass dominated by filamentous PHA-accumulating bacteria.

Biomass is typically maintained in a wastewater treatment system by means of a separation stage that utilizes density differences and/or principles of size exclusion. For example, flocculating biomass aggregates can be readily retained in a system that utilizes gravity separation. Less compact biomass structures can be effectively removed by flotation by introducing fine air bubbles that become entrapped in the biomass structure. One such process is dissolved air flotation, discussed above. Species that readily form mats can be separated by exclusion with less expensive sieve filtration systems.

The method or process of the present invention also enriches the filamentous bacteria in the biomass as to enhance the biomass's capacity or potential for PHA production. This enrichment process is referred to as feast and famine conditions or conditioning. Generally organic loading is such that individual organisms experience alternating periods of feast conditions and famine conditions. Under feast conditions the process is controlled such that there is an excess of readily biodegradable organic substrates expressed as readily biodegradable chemical oxygen demand (RBCOD) made available to the organisms. Readily biodegradable chemical oxygen demand of a wastewater is defined by a respiration response of biomass (RBCOD; Henze et al. 2000. IWA Scientific and Technical Report No 9, Activated Sludge Models ASM1, ASM2, ASM2D and ASM3. IWA Publishing, London). RBCOD includes volatile fatty acids (VFAs). VFAs are also well established substrates for PHA accumulation in activated sludge biomass. However, other forms of RBCOD are known to stimulate a feast response in biomass.

Under famine conditions there is the limitation of this readily available biodegradable organic substrate. As described in more detail hereafter, the feast environment is generally defined by an initial stimulating feast concentration of at least 10 mg-RBCOD/L and the feast should generally constitute less than 25% of the feast-famine exposure time. Famine can be achieved within the same reactor volume as feast, or in a separate sidestream or offline reactor where, for example, thickened biomass can be subjected to famine conditions since aeration requirements for famine conditions are generally significantly lower than for feast conditions. RBCOD levels during famine should ideally be effectively zero or generally less than about 2 mg-RBCOD/L. Due to the relatively low fraction of traditional activated sludge floc structures in the filamentous activated sludge and the high surface area to volume of this biomass, wastewater aerobic conditions are generally operationally defined as being measurable dissolved oxygen levels. Thus, dissolved oxygen levels that are lower than what is typically found in activated sludge systems are sufficient to facilitate high aeration mass transfer efficiency. Furthermore, relatively low dissolved oxygen levels have additional utility in that such further acts to select filamentous species over non-filamentous species, again due to the inherently high surface area to volume ratio compared to conventional floc biomass structures.

The term RBCOD is defined above. The term OBCOD may be used herein, and generally refers to other biodegradable chemical oxygen demand. As used herein, OBCOD means biodegradable wastewater organic matter that is not RBCOD. OBCOD may be comprised of COD that microorganisms that cannot convert into PHA. OBCOD may nevertheless be convertible to RBCOD.

Often wastewater will contain both RBCOD and OBCOD. In many cases the fraction of COD in the wastewater represented by RBCOD can be significantly increased by fermentation. Therefore, in some cases, an acidogenic phase unit process is employed as a preconditioning wastewater process that, as an example, promotes acidogenic microbial activity and so enriches or enhances the RBCOD fraction of the COD in the wastewater. The extent of conversion to RBCOD may be limited by the bioprocess, or more practical or economic considerations. In a preferred embodiment, it is beneficial that the RBCOD fraction of the COD in the wastewater be substantial. It is not critical that 100% of the RBCOD be in the form of VFA. Successful enrichment for PHA production potential in activated sludge has been achieved where as little as 25% of the RBCOD is in the form of VFA.

The contrasting feast and famine environments can be separated in time and carried out in the same reactor or can be separated in space due to process hydraulics with or without biomass separation. The alternating feast or famine conditions tend to promote the enrichment of PHA accumulating species, particularly if the famine exposure time is sufficiently long. It is hypothesized that PHA accumulating microorganisms can be stably selected if the feast represents no more than approximately 25% of the effective feast-famine biomass retention time. Experiments were conducted to stimulate a famine biomass to RBCOD and respirometric activity was observed. Biomass samples from a sequencing batch reactor treating a dairy wastewater with feast and famine cycles of 12 hours were studied.

The substrate concentration (Sₜ) necessary to stimulate a measurable respirometric response was considered a threshold concentration for a feast environment. The substrate concentration (Sₘ) necessary to stimulate the maximum specific uptake rate (qₘ) was considered sufficient substrate required to drive a feast physiological response. The substrate concentration at half the maximum specific substrate uptake rate (qₛ) was defined as Sₛ. The biomass physiological response to feast was variable in repeated experiences but some important trends were observed:
The extant biomass Sₘ level correlated directly with Sₜ, Sₛ and qₘ.
Sₘ ranged from 35 to 120 mg-RBCOD/L.
Sₛ was consistently about 27% of Sₘ and was observed in the range from 10 to 35 mg-RBCOD/L.
Sₜ was consistently about 8% of Sₘ was observed in the range from 2 to 10 mg-RBCOD/L.
Different respirometric responses were not necessarily indicative of differences in biomass capacity to accumulate PHA.
RBCOD uptake rate subsequent to the biomass stimulus from initial concentrations at and above Sₜ was zero order to levels well below Sₜ.

Therefore, biomass should be stimulated into feast with an initial RBCOD concentration over about 10 but ideally over 100 mg-RBCOD/L but still being lower than levels that would inhibit the biomass during the feast physiological response. Famine should be maintained with a RBCOD concentration under 2 mg-RBCOD/L, but ideally at levels of effectively zero RBCOD. As discussed further below, famine conditions could be compromised by OBCOD organic matter in the wastewater. Where OBCOD exists additional process design considerations may be necessary.

Feast conditions and famine conditions commonly include supply of oxygen (aerobic conditions) or nitrate (anoxic conditions) as electron acceptors. However, they may also be carried out under anaerobic conditions. Anaerobic conditions are here defined as absence of oxygen and nitrate as electron acceptors.

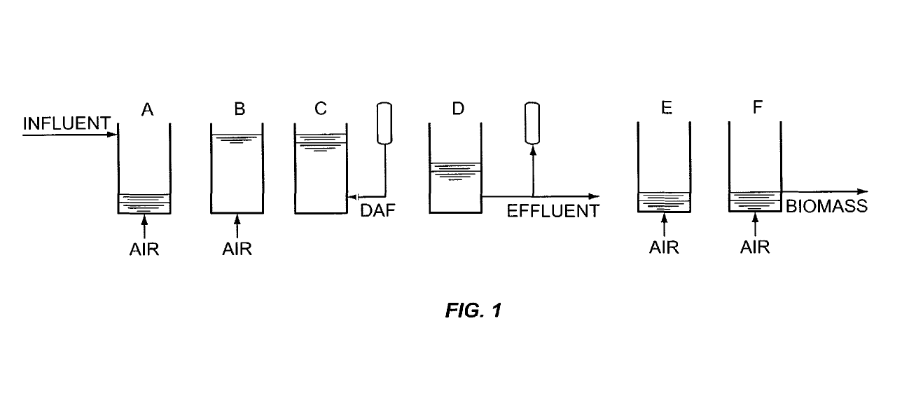

Turning to the drawings, FIG. 1 is a schematic illustration of a sequencing batch reactor (SBR) that is utilized to carry out the method or the process of the present invention. As discussed below, the sequencing batch reactor is operative to treat the wastewater and remove organic contaminants from the wastewater and at the same time the process is operative to enrich for and produce a biomass with high PHA accumulation capacity or potential. More particularly, the sequencing batch reactor will select filamentous biomass and utilize that filamentous biomass to remove organic contaminants from the wastewater while at the same time enhancing the PHA accumulation potential of this biomass.

With reference to FIG. 1, in Sequence A wastewater influent is directed into the reactor and existing biomass is disposed in the bottom of the reactor. Aeration is provided to the reactor, and as seen in Sequence B, the aeration will mix the wastewater and biomass and in this illustration, the biomass is subjected to feast conditions in the reactor shown in Sequence B. That is, the biomass is stimulated to aerobic feast metabolism by the wastewater influent. Thus, in Sequence B feast conditions are established and controlled and this process plays a roll in selecting filamentous microorganisms, and at the same time conditions the biomass so as to enrich or enhance the PHA production potential of the biomass.

After the feast conditions have been satisfied, the biomass is separated from the wastewater or mixed liquor contained in the reactor. This is illustrated in Sequence C. While various separation techniques may be employed, in the process described herein, a dissolved air flotation process is utilized to separate the biomass. Note in Sequence C where the dissolved air flotation causes the biomass to rise to the surface of the wastewater or mixed liquor in the reactor. Then in Sequence D, the effluent can be removed from the reactor and this leaves a concentrated filamentous biomass. This concentrated filamentous biomass is now disposed in the bottom of the reactor as shown in Sequence E. Now aerobic famine conditions can be applied. Air is directed into the reactor for a selected time period and the biomass is exposed to famine conditions as described above. Once the famine treatment period is concluded, the biomass can be removed from the reactor as illustrated in Sequence F. The biomass can be withdrawn from the reactor to maintain SRT control, and furthermore, the biomass can be directed downstream or offsite for further processing for PHA production. Removal of biomass may also be conducted at other stages (C-E) of the cycle. Termination of feast conditions are indirectly evident from changes in biomass respiration as derived, by example, from dissolved oxygen monitoring. End of feast conditions can also be monitored directly based on specific or non-specific on-line measurement methods for determining dissolved organic matter concentration. The process of FIG. 1 may also be carried out with removal of effluent after the famine treatment period.

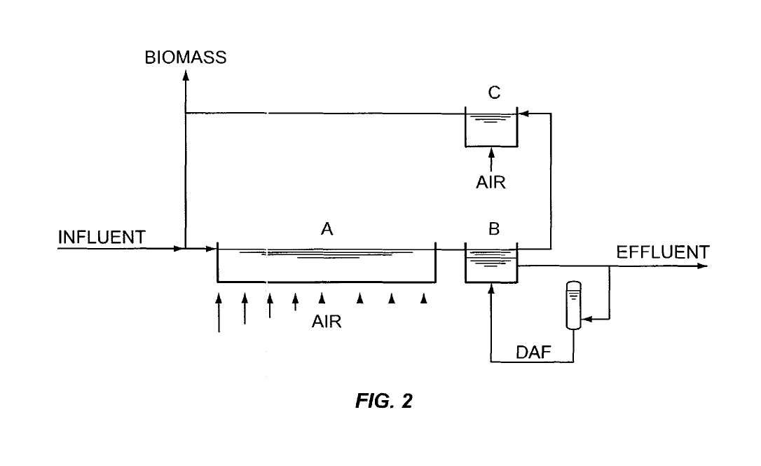

The present method or process can be carried out in various types of wastewater treatment systems. FIG. 2 illustrates a continuous plug flow wastewater treatment system. This system, like the sequencing batch reactor described in FIG. 1, selects filamentous biomass with PHA accumulation potential and uses that filamentous biomass to treat the wastewater and remove organic contaminants therefrom. Viewing FIG. 2, wastewater influent is directed into Reactor A. Air is supplied causing the filamentous biomass to be mixed with the influent wastewater in the aerobic plug flow Reactor A. Feast conditions are generally stimulated in Reactor A and feast attenuates over the length of the plug flow reactor. At the same time the selected filamentous biomass performs wastewater treatment in Reactor A and is generally effective to remove organic contaminants from the wastewater. After a selected period of time, which is a controlled by the influent flow rate and reactor A volume, the biomass and wastewater or mixed liquor is transferred to a Separator B. Here effluent is separated from the filamentous biomass by a dissolved air flotation (DAF) process. Note that effluent or treated wastewater is directed from the Separator B. The separated biomass in the separator is transferred to Reactor C. The biomass through separation is generally concentrated and in this particular case, Reactor C is designed to impart famine conditions to the concentrated filamentous biomass. Once the concentrated biomass has been adequately treated, as discussed above, to meet the requirements of famine, some of the biomass is returned and mixed with the influent wastewater. Other portions of the biomass are withdrawn from the system and process for SRT control and for further processing for PHA production. Alternatively, the biomass may be subjected to famine conditions prior to the separation from the wastewater.

The operating conditions for the method or process disclosed herein can vary depending on applications and the particular makeup of the wastewater being treated. Table 1 appearing below describes general or typical operating parameters that are effective in the method or processes described above, particularly with respect to selecting filamentous microorganisms and enriching the PHA production potential of such filamentous microorganisms while treating a fermented dairy industry wastewater.

TABLE 1
Exemplary operating parameters for the
enrichment of PHA-storing organisms

| Operating parameters | Range of values |
|---|---|
| Hydraulic retention time—HRT (d) | 0.25-2 |
| Solids retention time—SRT (d) | 2-8 |
| Feast/cycle length | 0.06-0.20 |
| Maximum COD_{VFA} concentration per cycle (g L⁻¹) | 0.8-1.5 |
| COD:N (g:g) | 200:4.5 |

In some cases, the term PAB is used herein to refer to PHA accumulating bacteria. Consistent with the discussion appearing above, PAB are bacteria exhibiting the ability to assimilate an organic substrate and store that substrate internally as granules of polyhydroxalkanoates. A mixed culture process enriched for PAB may comprise many different microorganisms in the biomass, but notwithstanding the community species diversity, this biomass can be made to accumulate PHA to significant levels if the biomass is fed with RBCOD. The term non-PAB refers to non-PHA accumulating bacteria. A successful biomass enrichment for PHA production potential from wastewater involves the preferential increase of PAB over non-PAB.

In the discussions appearing above, feast and famine conditions have been described and discussed in the context of enhancing the PHA production potential of mixed culture microorganisms. Discussed below is a feast unit process (FeUP). A FeUP can be aerobic, anoxic, or anaerobic. Generally, the FeUP is characterized by the removal of RBCOD, sometimes the rapid removal of RBCOD, from the wastewater. In general, the objective of a FeUP is to provide a selective advantage to PAB metabolism by establishing conditions of feast as defined above. If the FeUP is preceded by a sufficiently long period of famine, PAB generally have a selective advantage in the process. Since PAB can subsequently grow on their stored PHA, the FeUP is intended to selectively provide PAB with the majority share of the RBCOD supply for feast. PAB will tend to dominate the biomass over time due to its greater access to RBCOD. The greater the share of RBCOD that PAB receives over non-PAB, the more the PAB will replicate and so dominate over the non-PAB in numbers. During feast the fraction of OBCOD consumption may be low.

Feast conditions will generally end when RBCOD is either removed from the wastewater and/or becomes diluted due to changes in mixing hydraulics and/or design of volumes or mixing conditions in the process change. In the end, feast can no longer continue if RBCOD is at very small or negligible concentrations.

In addition, the term famine unit process (FaUP) will be used from time-to-time. A FaUP can be an anoxic or aerobic unit process. A FaUP is a unit process where in a preferred process, both RBCOD and OBCOD, are negligible in concentration. Thus, famine conditions are promoted by the absence of external organic substrate. The FaUP is not intended to serve a necessary function in dissolved organic carbon removal from the wastewater. The FaUP is directed at starving the biomass so as to reduce the extant level of intracellular PHA for PAB growth and survival.

FaUP, in a preferred system, is designed to promote starvation in order to achieve the desired PAB-selection environment during the subsequent FeUP cycle. If the wastewater still contained OBCOD during FaUP, then requisite famine conditions may not be achieved and the PAB enrichment strategy of “feast-famine” becomes significantly weakened, or in the worst case, it will fail.

In some of the drawings appended to the present application, other terms are used. For example, a biological unit process is referred to as BioUP. The BioUP can be an anoxic, aerobic, or anaerobic unit process. Generally, the BioUP is characterized by negligible levels of RBCOD and the degradation of influent OBCOD. The term “biomass separation unit process” is referred to by BSepUP. This is a unit process for separating biomass from water. Examples of a BSepUP are gravity clarifiers, filtration screens, dissolved air flotation units, and ballasted sedimentation.

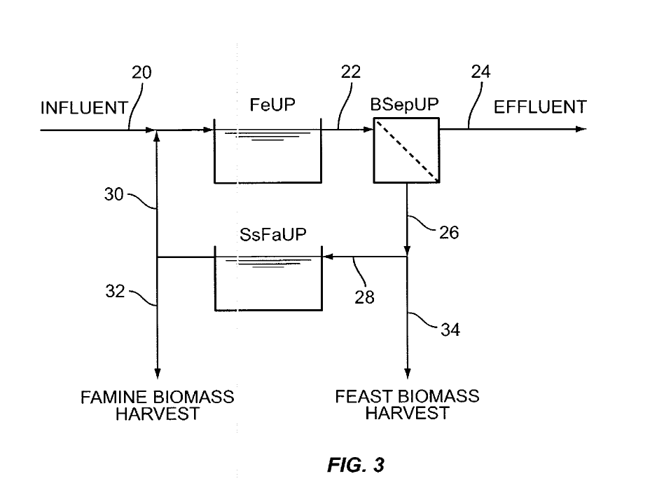

FIGS. 3-6 show various processes for enhancing the PHA production potential of microorganisms in wastewater treatment processes. In these three exemplary processes, the famine conditions discussed above are carried out in a sidestream. Thus, each of the processes depicted in FIGS. 3-6 include sidestream famine processes, and as depicted in these three schematic drawings, there is provided a sidestream famine unit process referred to by SsFaUP. A sidestream FaUP entails the separation of the biomass from treated or partially treated water for the purpose of subsequently treating the biomass that is generally decoupled hydraulically from the main wastewater flow. In general, the separation of the biomass results in the concentration of the biomass. In the case of the process embodiments shown in FIGS. 3-6, the separated biomass is exposed to famine conditions in the sidestream. The SsFaUP ensures the performance of PAB enrichment and results in other practical and economic benefits as the process, compared to a total mainstream process, reduces aeration cost and capital expenditures, especially with respect to tank volumes.

Turning specifically to the FIG. 3 process, wastewater influent is directed through line 20 into the FeUP. In this particular embodiment, wastewater treatment takes place in the FeUP. Further, the FeUP is designed to provide a feast response in the biomass. In many cases, all or substantially all of the RBCOD is removed during treatment in the FeUP. In a preferred process, all or most of the RBCOD is removed in the FeUP. In a preferred process, once a substantial fraction of the RBCOD is removed from the wastewater in the FeUP, then the biomass is separated. In the process of FIG. 3, the wastewater or mixed liquor treated in the FeUP is directed via line 22 to the BSepUP. Here, the biomass is separated from the treated effluent. That is, as FIG. 3 shows, the treated effluent is directed from the BSepUP via line 24. The biomass, on the other hand, is directed through line 26 to a sidestream 28. Sidestream 28 includes the SsFaUP. Here, the full extent of famine requirements for the selection process is achieved for the concentrated biomass in the SsFaUP. Once the biomass has been conditioned in the SsFaUP, the biomass can be recycled via line 30 to influent line 20. That is, the biomass that has been subjected to famine conditions in the SsFaUP is now directed to the FeUP where it is subjected to feast conditions. Biomass, after feast or famine can be harvested by directing the biomass from the BSepUP via line 34, or from the SsFaUP via line 32.

It should be noted that since famine conditions generally impart little or no further improvement to the wastewater quality with respect to RBCOD removal, the wastewater can be separated from the biomass directly after feast. Since the biomass may be significantly concentrated during separation, and sidestream flow rates may be reduced from the mainstream flow rate, the volume required for famine treatment will only be a fraction of the volume required had famine been performed in the mainstream treatment.

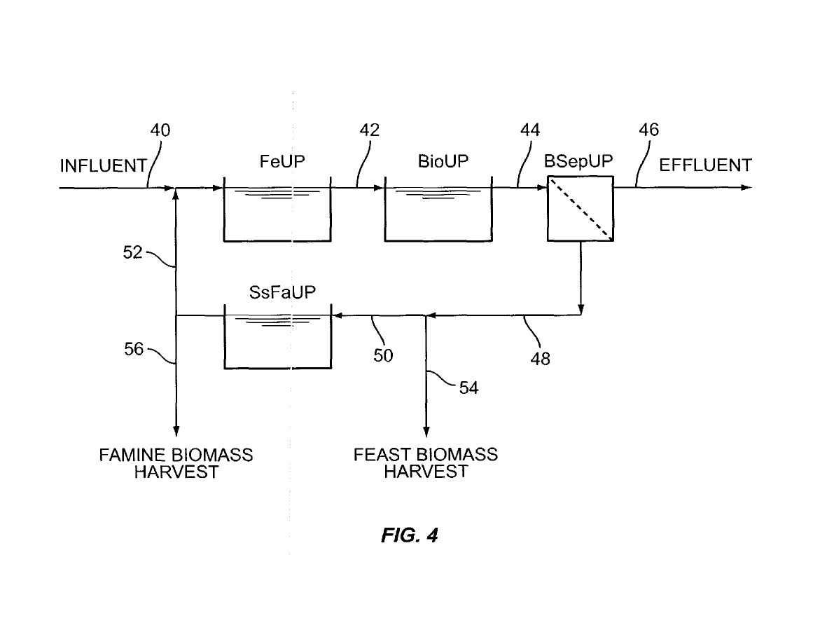

FIG. 4 depicts another process that includes a sidestream famine unit process. The organic content of some wastewaters entering the process may include OBCOD. A process, such as illustrated in FIG. 4, is designed to deal with this issue. If OBCOD is degraded subsequent to the removal of RBCOD, then effluent famine conditions cannot be achieved directly after the FeUP. Therefore, the process of FIG. 4 is designed to include a BioUP in series with the FeUP. Here, the biomass would be separated directly after the BioUP and famine conditions applied in the SsFaUP. More particularly, with reference to FIG. 4, wastewater influent is directed through line 40 to the FeUP. There, feast conditions are applied to the biomass. Effluent from the FeUP is directed through line 42 to the BioUP. The biomass in the BioUP is utilized to remove the OBCOD. Once famine conditions are realized in the BioUP, then it is appropriate to separate the biomass and direct the biomass to a famine unit process. In the FIG. 4 process, the effluent from the BioUP is directed through line 44 to the BSepUP. There, the biomass is separated from the treated effluent and the treated effluent is directed from the BSepUP via line 46. Separated biomass is directed to line 48 and then to sidestream 50. The SsFaUP is placed in the sidestream 50. The concentrated biomass is subjected to famine conditions in the SsFaUP. Thereafter, the biomass in the SsFaUP is directed to line 52 which effectively recycles the famine treated biomass back to the mainstream where the biomass is mixed with the influent wastewater in the FeUP. Biomass that is suitable for harvesting can be directed from the process through lines 54 and 56. That is, the biomass can be harvested either before or after being subjected to treatment in the SsFaUP.

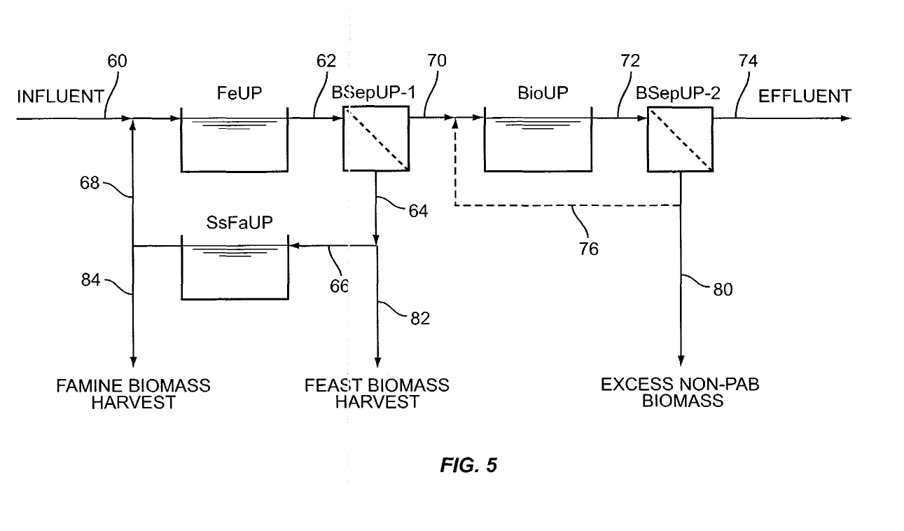

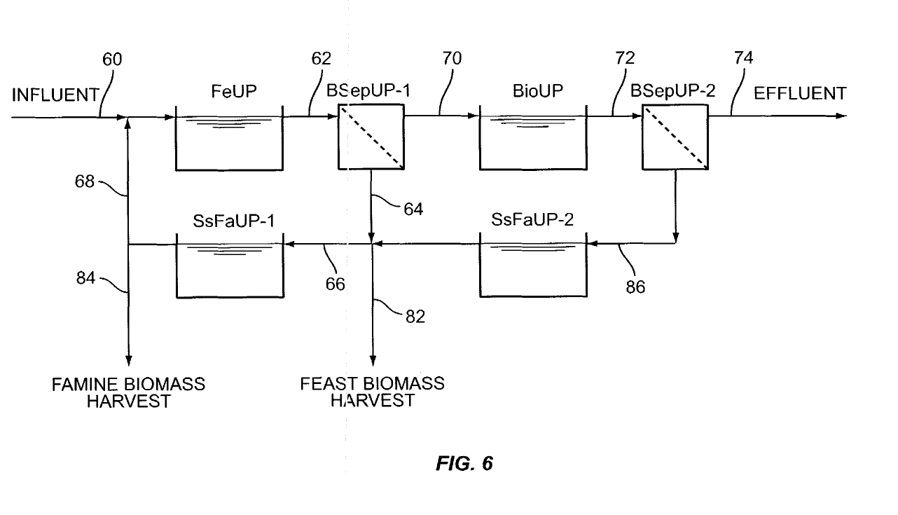

FIGS. 5 and 6 show alternative processes for enhancing the PHA storing potential of biomass. In both cases the wastewater to be treated contains a mixture of RBCOD and OBCOD. The BioUP in the process of FIG. 4 provides an opportunity for PAB and non-PAB to grow alike. If the selection pressure imparted by the SsFaUP and the FeUP are significantly compromised by non-PAB growth during the BioUP, then performance of PHA production will be likewise impacted. Rather than treat the OBCOD in the BioUP directly after the FeUP, the biomass can be separated from the wastewater after the FeUP and this biomass can be conditioned in the SsFaUP. OBCOD can then be polished from the wastewater in a compact BioUP with a distinct biomass that is downstream of the PAB production/RBCOD treatment process. Alternatively, a fraction of the same biomass can be used in the downstream BioUP so long as the biomass stream is subjected to a more stringent secondary SsFaUP.

In the FIG. 5 process, wastewater influent is directed through line 60 into the FeUP where feast conditions are applied. From FeUP, the wastewater is directed through line 62 to the BSepUP-1. Here, biomass is separated from the wastewater. Effluent from the BSepUP-1 is directed via line 70 into the BioUP. Here, the wastewater is treated. From the BioUP the wastewater is directed through line 72 to the BSepUP-2. Here, the treated effluent is directed from the BSepUP-2 via line 74 and excess non-PAB biomass is directed from the separator via line 80. In some cases, the separated biomass can be recycled via line 76 as shown in FIG. 5. In the process of FIG. 5 all of the RBCOD, or substantially all of the RBCOD, is removed in the FeUP, but remaining OBCOD compromises establishing a famine response in the biomass. PAB enriched biomass is harvested from the wastewater directly after the FeUP and processed for famine conditions in the SsFaUP. With reference to FIG. 5, the biomass separated by BSepUP-1 is directed through line 82 or to the sidestream 66 for conditioning in the SsFaUP. From the SsFaUP, the biomass can be recycled through line 68 where it is mixed with the wastewater influent in the FeUP. Feast and famine biomass can be harvested from lines 82 and 84 respectively. Excess non-PAB biomass can be discharged through line 80.

The process of FIG. 6 is similar in some respects to the processes discussed above with respect to FIG. 5. Here, PAB enriched biomass is partially harvested from the wastewater directly after the FeUP and processed for famine treatment in the SsFaUP-1. Some biomass left to pass through the BSepUP-1 is used to remove OBCOD in the BioUP. The full extent of famine requirements for the selection process is achieved for the biomass concentrated in the SsFaUP-1. Additional requisite famine time is provided in SsFaUP-2 for the fraction of the biomass used for OBCOD removal and separated in the BSepUP-2.

The processes shown in FIGS. 3-6 involve a mainstream and a sidestream where microorganisms are subjected to famine conditions. For example, in FIG. 3 the mainstream comprises the lines 20, 22 and 24 while the sidestream comprises line 28. In the FIG. 4 process, the mainstream comprises lines 40, 42, 44 and 46 while the sidestream is made up of line 50. Thus, the process shown in FIGS. 3-6 all involve sidestream processes and more particularly, sidestream processes that include the sidestream famine unit process.

### Example 1

### Laboratory-Scale Tanks in Series Treating a Paper Mill Wastewater

A laboratory-scale reactor system was operated according to the principle of the embodiment of FIG. 2 to enrich for a filamentous biomass while treating a fermented wastewater from a paper mill. The wastewater had previously been subjected to acidogenic fermentation in an anaerobic continuous flow stirred-tank reactor (retention time 16 h, temperature of 30° C., and pH controlled at 6.0). The VFA levels in the fermented wastewater were 1850 mgCOD/L acetate, 2120 mgCOD/L propionate, 1010 mgCOD/L butyrate and 350 mgCOD/L valerate. The concentration of soluble COD (SCOD) was 7360 mg/L and the SCOD:N:P mass ratio was 100:4.4:1.3. The enrichment system comprised two aerobic reactors in series, a feast reactor (125 mL) followed by a famine reactor (2 L), and a clarifier (300 mL) with sludge return flow to the feast reactor. The inflow of fermented effluent to the feast reactor was 600 mL/day and the sludge return flow was 900 mL/day. The DO concentrations and temperature in both reactors were above 2 mg/L and 30° C., respectively. The SRT was 7 days, and pH in the famine reactor was controlled at 7.3 by automatic addition of 2 M HCI. The volumetric organic loading rate was 2.1 gSCOD/L d and the specific organic loading rate was 0.51 gSCOD/gVSS d.

The filament abundance and biomass morphology were regularly monitored by phase contrast and differential interference microscopy. In order to identify the dominating filamentous microorganism, fluorescence in-situ hybridisation was performed. Batch experiments were conducted in order to determine the PHA accumulation potential of the filamentous biomass. Wastewater with lower levels of N and P was mixed with biomass from the famine reactor in separate batch reactors that were stirred, aerated, and temperature-controlled at 30° C. Batch experiments were conducted for 24 h and pH was controlled at 7.3 by addition of 1 M HCl.

Within a couple of weeks after the startup of the system using sludge from a municipal wastewater treatment plant as inoculum, the biomass was highly enriched in filamentous bacteria. A high level of enrichment of filamentous bacteria was concluded based on a visual estimation using light microscopy. Filamentous biomass made up more than 50% of the total biomass. An alternative measure of filament abundance is the Filament Index (Eikelboom, D. 2000. Process Control of Activated Sludge Plants by Microscopic Investigations, IWA Publishing, London). With a scale from 0 to 5, high filament abundance is reflected by Filament Indexes equal to or above three. In this particular example, the Filament Index was approximately five. In the first phase of the operation (4 months), the feast reactor working volume was gradually decreased from 200 mL to 125 mL in order to obtain feast conditions in the reactor. With 125 mL, an average VFA concentration of 150 mgCOD/L was observed in the feast reactor's outlet which assured a RBCOD concentration of at least the same level. The famine reactor outlet contained no VFAs above the detection limit, indicating famine conditions. The COD removal over the process was 95%.

From this point, the selector volume was maintained at 125 mL and the reactor system was operated under stable conditions. The biomass continued to be dominated by filamentous bacteria throughout the total operational period of almost two years. No supplementary micronutrients were added to the system and it is believed that filamentous organisms were favored by the scarcity of one or several micronutrients.

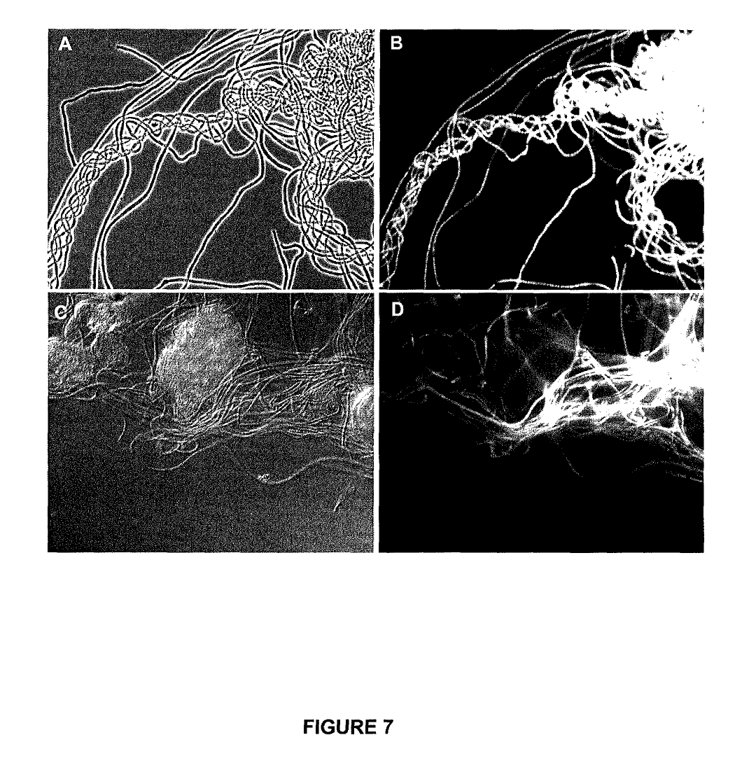

Presence of PHA inclusions in the filaments was confirmed by Nile blue A staining (See FIG. 7, photographs, A and B). It was found that nearly all of the filaments present in the biomass were targeted by oligonucleotide probes designed for Meganema perideroedes and labeled with the fluorochrome Cy3 (See FIG. 7, photographs, C and D).

The filamentous biomass was found to accumulate 43-48% PHA of biomass dry weight under nutrient (N and/or P) limiting conditions in the batch experiments. The PHA contained monomers of hydroxybutyrate and hydroxyvalerate (53-61 mol %).

### Example 2

### Laboratory-Scale Tanks in Series Treating a Synthetic Wastewater

A similar system as the one outlined above was operated to treat a synthetic wastewater. The reactor volumes and flow rates were half of those stated in the previous example, namely, feast reactor (62.5 mL), famine reactor (1 L), clarifier (150 mL), influent substrate flow (300 mL/day) and sludge return flow (450 mL/day). The DO levels were above 2 mg/L, the SRT 7 days and the temperature 30° C. The synthetic wastewater contained 2729 mgCOD/L acetate, 1104 mgCOD/L propionate, 197 mgCOD/L iso-butyrate, 440 mgCOD/L n-butyrate, 171 mgCOD/L iso-valerate, 145 mgCOD/L valerate, 44 mgCOD/L methanol and 22 mgCOD/L ethanol. Nitrogen and phosphorus sources as well as micronutrients were supplied in excess of growth requirements. The volumetric organic loading rate was thus 1.4 gSCOD/L d and the specific organic loading rate was 0.49 gSCOD/gVSS day.

Also in this system, a few weeks after inoculation with sludge from a municipal wastewater treatment plant, the biomass was dominated by filamentous bacteria. The filamentous biomass was maintained in the reactor during two months of operation. Microscopic examination revealed that the dominating filament had identical morphology and similar abundance as that in the system operated to treat the paper mill effluent. Thus, it was most likely a closely related organism and this culture was anticipated to have a similar PHA accumulation potential.

PHA inclusions in the filaments were confirmed with Nile blue A staining. A feast and famine behavior by the biomass was confirmed based on a comparatively much higher staining response of the biomass from the selector than that from the main reactor.

### Example 3

### Pilot-Scale SBR Treating a Diary Wastewater

The enrichment of filamentous biomass with PHA-storing capacity was studied during two periods of 8 months in a pilot-scale (400 L) SBR treating fermented dairy wastewater rich in VFAs on the principle of the embodiment of FIG. 1. The dairy wastewater was first fermented (200 L anaerobic fermenter) as to enrich it in VFAs and then treated in the SBR, which was operated with feast and famine cycles to ensure the selection of PHA-storing bacteria.

During a first operating period, the SBR was operated with feast and famine cycles of 12 hours, an HRT of 1 d, SRT between 1-4 d, an organic loading rate of 1.5 g RBCOD/L d, and a COD:N mass ratio of 200:4. The SBR underwent different conditions of SRT, specific organic loading rates, micronutrient loading rates and temperature that correlated to the abundance of filamentous organisms, as reflected in the sludge volume index (SVI) of the sludge (Table 2). The micronutrients and the corresponding threshold loading rates determining high (above the threshold) or low (below the threshold) values are presented in Table 3.

The main manipulated variable during this experimental period was the micronutrient loading rate; however, other operating parameters such as the SRT and the specific organic loading rate changed according to the solids retention capacity of the system dictated by the settleability of the biomass (e.g., period1b, Table 2). The temperature was only regulated by heating; therefore, temperatures higher than 20° C. were experienced during the summer months (period 3, Table 2).

Filament identification was conducted via fluorescence in-situ hybridization (FISH) similarly as to Example 1, but the oligonucleotide probe targeting the filamentous bacterium Sphaerotilus natans was also used.

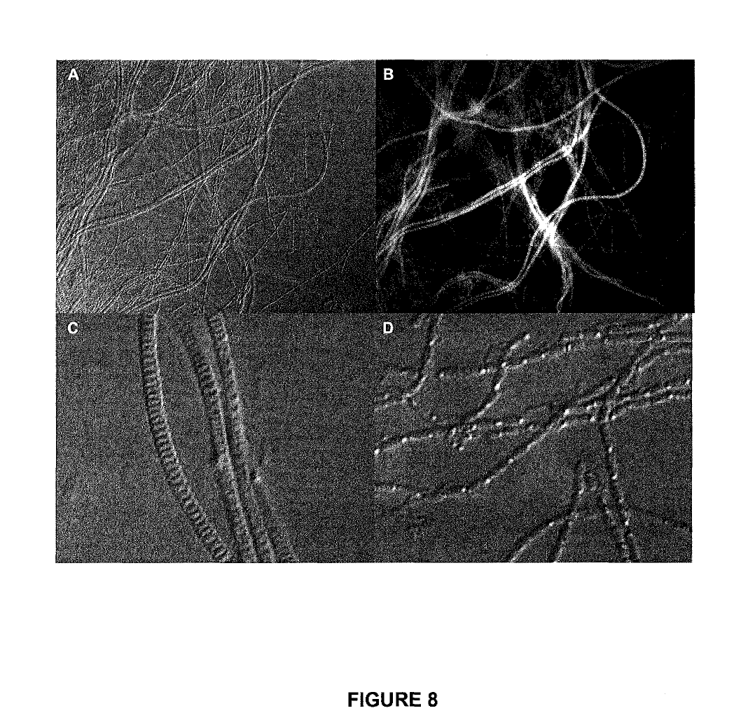

Exposing activated sludge biomass to low (limiting) micronutrient loads (periods 1a and 4, Table 2) induced the proliferation of filamentous biomass and the increase in SVI leading to sludge bulking and biomass loss through the effluent. However, increasing the micronutrient loading rates triggered a decrease in the filament abundance of the biomass (periods 2 and 5, Table 2), which recovered the solids retention capacity of the system and increased the SRT and decreased the specific organic loading rates. In addition, applying slightly higher micronutrient loading rates at operating temperatures higher than 21° C. maintained low filament abundance and SVIs (period 3, Table 2). Increasing the loading rates of specifically Fe³⁺, Zn²⁺, Co²⁺, Cu²⁺, Mo⁶⁺ resulted in a decrease in filamentous abundance and SVIs (period 5, Table 2). The most abundant filamentous bacterium identified in biomass samples taken during incidents of sludge bulking and high SVIs (periods 2 and early period 5) was Meganema perideroedes (See FIG. 8). The filamentous bacterium Sphaerotilus natans was also abundant constituting from approximately 10 to 40% of the filamentous biomass based on microscopic observations (See FIG. 8).

The SBR achieved 98% COD removal efficiencies with levels of 200 mg COD/L in the treated effluent. The accumulation capacity of the filamentous biomass was of 40% (gPHA/gTSS) as tested in lab-scale fed-batch tests with the same fermented diary wastewater. The polymer produced from this specific substrate consisted of mainly hydroxybutyrate with some hydroxyvalerate content of up to 10 mass %.

During a second operating period, the SBR was operated under similar conditions as in the first period with an organic loading rate of 1.5 g RBCOD/L d and feast-famine cycles of 12 hours. However, the HRT ranged within 1-1.5 d, and the SRT between 1-2 d during periods of biomass loss through the effluent due to filamentous bulking and 4-8 d during decreased filament abundance. Similarly as in the first operating period, SRTs, specific organic loading rates, micronutrient loading rates and SVIs were influenced by high filament abundance causing sludge bulking and reduced solids retention. COD:N mass ratios of 200:4-6 were maintained, and the specific sludge loading rates varied from 0.5 to 2 gCOD/gTSS d. Micronutrient loading rates were applied at the border or below the thresholds of Table 3, except for Fe³⁺ and Zn²⁺ whose concentrations were in excess. During this experimental period only temperature was changed significantly from 17° to 30° C. after 2.5 months of operation.

High levels of filamentous abundance and high SVIs between 400 and 800 mL/g were observed when operating the SBR with low (limiting) micronutrient loading rates at a temperature of 17° C., in agreement with observations from the first operating period. Both previously observed filamentous bacteria were detected in the bulking biomass of this period; however, in this case, M. perideroedes was the most abundant filament (<95%). The high loading rates of Fe³⁺ and Zn²⁺ had no effect on the filamentous abundance of the biomass. Nevertheless, increasing the temperature from 17° to 30° C. decreased the abundance of filamentous bacteria and eliminated sludge filamentous bulking, which consequently eliminated biomass losses through the effluent. An increase in biomass aggregates or flocs was also observed, and although some low levels of filaments remain in the sludge biomass, they never overgrew the flocculating bacteria.

In addition, filamentous biomass taken during this second operating period from the pilot SBR was subjected to high micronutrient loading rates and an elevated temperature of 30° C. in a lab-scale reactor in order to assess the effects of these operating conditions on the filamentous biomass. The lab-scale reactor (4 L) was operated with the same fermented diary wastewater under similar conditions as the pilot SBR except for the higher micronutrient loading rates and temperature. After biomass transfer, loss of biomass was observed via the effluent due most likely to sludge deflocculation due to the temperature shock and the still prevalent high filament abundance. However, the filament abundance decreased overtime and, after six weeks, the biomass was low in filament abundance and presented good sludge settleability.

### Tables

TABLE 2
Summary of the SBR operating conditions and observations made
chronologically with respect to filament abundance

| | | | Specific organic | | | |
|---|---|---|---|---|---|---|
| | Filament | | loading rate | | | |
| Period of | propensity | SRT | (gCODₛₒₗ/gVSS | Micronutrient | Temperature | Operating |
| observation | (as SVI) | (d) | d) | loading rates | (° C.) | days |
| 1a | High* | 4 | 0.85 | Low (limitation) | 17-21 | 0-100 |
| 1b | High | 1 | 2.1 | | | |
| 2 | Low | 1-2 | 1.7 | High (excess) | 17-21 | 100-120 |
| 3 | Low | 3 | 1.3 | Medium** | 21-24 | 120-126 |
| 4 | High* | 3-4 | 1.3-1 | Low (limitation) | 18-21 | 126-150 |
| 5 | Low | 4 | 0.85 | High*** (excess) | 14-20 | 150-245 |

*Conditions selecting for high filament abundance/onset of high filament abundance
**Slightly above threshold values
***With respect to Fe³⁺, Zn²⁺, Co²⁺, Cu²⁺, and Mo⁶⁺

TABLE 3
Threshold values determining high and low loading rates
to the SBR (Table 1) of relevant micronutrients

| | Loading rates | |
|---|---|---|
| Micronutrient | mg/gRBCOD | mg/gTSS d |
| P⁵⁺* | 10 | 7 |
| K⁺ | 40 | 25 |
| S²⁻ | 1.5 | 1 |
| Mg²⁺ | 2 | 1.5 |
| Ca²⁺ | 10 | 8 |
| Fe³⁺ | 0.4 | 0.3 |
| Zn²⁺ | 0.04 | 0.03 |
| Mn²⁺ | 0.05 | 0.04 |
| Co²⁺ | 0.05 | 0.04 |
| Cu²⁺ | 0.01 | 0.008 |
| Mo⁶⁺ | 0.03 | 0.025 |

*P loaded as part of the diary wastewater feed. P was not supplemented.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of treating wastewater with filamentous biomass and producing a polyhydroxyalkanoate (PHA)-storing filamentous biomass under conditions where the filamentous biomass is selected and caused to proliferate to dominate an activated sludge, the method including:
mixing the wastewater with the activated sludge;
selecting a filament dominated biomass and causing the filamentous biomass to proliferate and dominate over non-filamentous biomass in the activated sludge;
treating the wastewater with the filamentous biomass by utilizing the filamentous biomass to remove contaminants from the wastewater;
enhancing the PHA production potential of the filamentous biomass by subjecting the filamentous biomass to alternating feast and famine conditions where under feast conditions more biodegradable organic substrate is available to the filamentous biomass than under famine conditions; and
separating the PHA enriched filamentous biomass from the wastewater such that further PHA accumulation or harvesting from the filamentous biomass can occur.

2. The method of claim 1 including subjecting the filamentous biomass to alternating feast and famine conditions; and wherein separating the filamentous biomass from the wastewater is performed by a dissolved air flotation process, a screening process or a filtration process.

3. The method of claim 1, wherein the aerobic famine condition includes an oxygen supply rate less than the aerobic feast condition.

4. The method of claim 1, wherein at least one of the micronutrients in form of ions of K, S, Mg, Ca, Fe, Zn, Mn, Co, Cu, Mo, B, Cl, V and Na is maintained on a level that is limiting for growth of non-filamentous biomass in the process.

5. The method of claim 1, wherein the feast and famine conditions give rise to feast treatment and famine treatment, and wherein the feast treatment is performed in a first reactor and wherein the famine treatment is performed in a second reactor wherein the second reactor is located downstream of the first reactor or in a side stream.

6. The method of claim 1, wherein the filamentous biomass is subjected to alternating periods of feast treatment and famine treatment, and wherein the feast treatment is less than or equal to 25% of the of the combined feast and famine period to which the biomass is cyclically exposed.

7. The method of claim 1, wherein the concentration of the readily biodegradable organic substrate under feast conditions is at least approximately 10 mg-RBCOD/L, and the concentration of the readily biodegradable organic substrate under famine conditions is approximately 2 mg-RBCOD/L or less.

8. The method of claim 7, wherein the maximum concentration of the readily biodegradable organic substrate available to the filamentous biomass under feast conditions is approximately 10 to approximately 5000 mg-RBCOD/L, and the concentration of the readily biodegradable organic substrate available to the filamentous biomass under famine conditions is approximately 0 to 2 mg-RBCOD/L.

9. The method of claim 7, wherein the concentration of the readily biodegradable organic substrate made available to the filamentous biomass under feast conditions is at least 50 mg-RBCOD/L.

10. The method of claim 1, wherein selecting filamentous biomass includes controlling sludge retention time to between approximately one day and approximately eight days.

11. The method of claim 1 wherein selecting filamentous biomass includes controlling the sludge retention time to less than 4 days.

12. The method of claim 1, wherein the method is performed in a sequencing batch reactor and includes:
directing the wastewater into the reactor;
mixing the wastewater with the filamentous biomass in the reactor under aerobic conditions to form mixed liquor;
separating the filamentous biomass from the mixed liquor; and
removing an effluent from the reactor leaving a concentrated filamentous biomass.

13. The method of claim 12 further including:
after removing the effluent, leaving the concentrated filamentous biomass in the reactor, and subjecting the concentrated filamentous biomass to famine conditions.

14. The method of claim 12 including:
selecting the filamentous biomass by controlling sludge retention time by removing portions of the filamentous biomass from the reactor; and
using removed filamentous biomass for further processing towards extracting accumulated PHA.

15. The method of claim 1 including selecting the PHA producing filamentous biomass and treating the wastewater with the filamentous biomass in a sequencing batch reactor.

16. The method of claim 15 including:
mixing the wastewater and the filamentous biomass in a sequencing batch reactor;
subjecting the filamentous biomass to feast conditions in the sequencing batch reactor;
separating the filamentous biomass from the wastewater and withdrawing a substantial portion of the wastewater from the sequencing batch reactor, leaving a concentrated filamentous biomass in the sequencing batch reactor; and
subjecting the concentrated filamentous biomass to famine conditions in the sequencing batch reactor.

17. The method of claim 16 wherein selecting filamentous biomass is achieved in part at least by controlling sludge retention time, and wherein sludge retention time is controlled by withdrawing portions of the filamentous biomass from the sequencing batch reactor.

18. The method of claim 17 including controlling sludge retention time by maintaining sludge retention time to approximately 1 day to approximately 8 days.

19. The method of claim 16 wherein the separation of the filamentous biomass from the wastewater in the sequencing batch reactor is conducted with a dissolved air flotation process.

20. The method of claim 1 including selecting PHA producing filamentous biomass and treating the wastewater with the filamentous biomass in a system having at least two separate reactors, the method including:
mixing the wastewater and filamentous biomass in a first reactor to form mixed liquor;
subjecting the filamentous biomass to feast conditions in the first reactor by maintaining the concentration of available organic substrate in the first reactor at approximately 10 mg-RBCOD/L and higher;
separating the filamentous biomass from the mixed liquor;
transferring the separated filamentous biomass to a second reactor;
subjecting the separated filamentous biomass to famine conditions by maintaining the concentration of available biodegradable organic substrate in the second reactor to 2 mg-RBCOD/L and less; and
after subjecting the filamentous biomass to famine conditions in the second reactor, returning at least a portion of the filamentous biomass and mixing the filamentous biomass with the wastewater.

21. The method of claim 20 wherein selecting the filamentous biomass includes controlling sludge retention time by withdrawing portions of the filamentous biomass such that the sludge retention time is maintained between approximately 1 day and approximately 8 days.

22. The method of claim 21 including subjecting the withdrawn filamentous biomass to further PHA accumulation or extraction.

23. A method of biologically treating wastewater with a biomass and producing a PHA storing biomass, the method including:
(a) mixing the wastewater and biomass and biologically treating the wastewater in a mainstream process to remove contaminants from the wastewater;
(b) enhancing the PHA production potential of the biomass through a biomass enrichment process by subjecting the biomass to alternating feast and famine conditions where under feast conditions more biodegradable organic substrate is available to the biomass than under famine conditions;
(c) separating the biomass from the wastewater to produce a treated effluent and a concentrated biomass;
(d) directing the concentrated biomass to a sidestream having at least one famine reactor in the sidestream;
(e) directing the concentrated biomass into the famine reactor(s) in the sidestream and subjecting the concentrated biomass to famine conditions in the famine reactor(s) in the sidestream and
(f) after the concentrated biomass has been subjected to famine conditions in the sidestream, recycling at least a portion of the concentrated biomass to the mainstream and mixing the concentrated biomass with the wastewater in the mainstream.

24. The method of claim 23 including subjecting the biomass to feast conditions in the main stream.

25. The method of claim 23 including subjecting the biomass to feast conditions in the main stream before the biomass is concentrated and directed to the side stream.

26. A method of biologically treating wastewater with a biomass and producing a PHA-storing biomass in a sequencing batch reactor, the method including:
(a) mixing the wastewater and biomass and biologically treating the wastewater to remove contaminants from the wastewater;
(b) enhancing the PHA production potential of the biomass through a biomass enrichment process by subjecting the biomass to alternating feast and famine conditions where under feast conditions more biodegradable organic substrate is available to the biomass than under famine conditions;
(c) separating the biomass from the wastewater to produce a treated effluent and a concentrated biomass;
(d) subjecting the concentrated biomass to famine conditions;
(e) after the concentrated biomass has been subjected to famine conditions in the reactor, leaving at least a portion of the concentrated biomass in the reactor to be mixed with the wastewater in the following sequencing batch reactor cycle.

27. The method of claim 23 wherein the mainstream includes at least one feast reactor for subjecting the biomass to feast conditions and at least one additional biological treatment reactor disposed downstream of the feast reactor; and wherein the method includes subjecting the biomass to feast conditions in the feast reactor prior to further treating the wastewater in the additional biological treatment reactor.

28. The method of claim 28 further including directing the wastewater and biomass from the biological treatment reactor to a downstream separator disposed in the mainstream and separating the biomass from the wastewater in the separator to form a treated effluent and a concentrated biomass; and directing the concentrated biomass to the famine reactor in the sidestream.

29. The method of claim 28 wherein the wastewater includes RBCOD, and wherein the method includes removing substantially all of the RBCOD in the feast reactor prior to the biomass being transferred from the feast reactor to the downstream biological treatment reactor.

30. The method of claim 30 in wherein the wastewater includes OBCOD, and wherein the method includes removing substantially all of the OBCOD from the wastewater in the biological treatment reactor before the biomass is subjected to famine conditions.

31. The method of claim 24 wherein the mainstream includes a feast reactor and an additional biological treatment reactor, and wherein there is at least one separator disposed between the feast reactor and the other biological treatment reactor for separating at least some of the biomass from the wastewater so as to produce a concentrated biomass that is subsequently subjected to famine conditions in the sidestream.

32. The method of claim 32 wherein the mainstream includes at least two separators, one separator disposed downstream of the feast reactor, and one separator disposed downstream of the biological treatment reactor.

33. The method of claim 32 wherein the sidestream includes at least two famine reactors connected in series.

34. The method of claim 24 wherein the mainstream includes a feast reactor, at least one additional biological treatment reactor, and two separators for separating biomass from the wastewater, and wherein one separator is disposed between the feast reactor and the additional biological treatment reactor, and the other separator is disposed downstream of the additional biological treatment reactor; and wherein the sidestream includes two famine reactors connected in series with one famine reactor operative to receive concentrated biomass that is separated from the wastewater by the separator disposed between the feast reactor in the additional biological treatment reactor, and wherein the other famine reactor receives concentrated biomass separated from the wastewater by the separator disposed downstream of the biological treatment reactor.
